(19) United States
(12) Patent Application Publication
(10) Pub. No.: US 2022/0367112 A1
(43) Pub. Date: Nov. 17, 2022

(54) PREFORMED CHIP MANUFACTURING APPARATUS, PREFORMED CHIP, DUST CORE MANUFACTURING APPARATUS, DUST CORE, PREFORMED CHIP MANUFACTURING METHOD, AND DUST CORE MANUFACTURING METHOD

(71) Applicants: Yoshiki Hirai, Tokyo (JP); HIRAI-HPM CO., LTD., Tokyo (JP)

(72) Inventor: Yoshiki HIRAI, Tokyo (JP)

(21) Appl. No.: 17/734,254

(22) Filed: May 2, 2022

(30) Foreign Application Priority Data
May 14, 2021 (JP) 2021-082324

(51) Int. Cl. H01F 41/02; H01F 27/255; B22F 3/03

(52) U.S. Cl. CPC H01F 41/0246; H01F 27/255; B22F 3/03; B22F 2202/05

(57) ABSTRACT

A preformed chip manufacturing apparatus includes a magnetic fixing suspension device including a pair of magnets which are a first magnet and a second magnet between which a magnetic field is formed for enabling a soft magnetic powder to be suspended therein, and a pair of punches configured to pressure mold the soft magnetic powder suspended in the magnetic field.

### CROSS-REFERENCE TO RELATED APPLICATION

This patent application is based upon and claims the benefit of priority under 35 USC 119 from Japanese Patent Application No. 2021-082324 filed on May 14, 2021, the entire disclosure of which, including the specification, claims, drawings and abstract, is incorporated herein by reference.

### BACKGROUND OF THE INVENTION

### Field of the Invention

The present invention relates to a preformed chip manufacturing apparatus, a preformed chip, a dust core manufacturing apparatus, a dust core, a preformed chip manufacturing method, and a dust core manufacturing method.

### Description of the Related Art

Conventionally, there have been disclosed dust core manufacturing methods and manufacturing apparatuses in which the magnetic characteristic of a dust core is improved. For example, Japanese Patent Laid-Open No. 2006-245055 discloses a dust core manufacturing apparatus and method in which magnetic powder containing flat Fe—Co based alloy powder is filled in a cavity in a molding die, and vibration is imparted to the magnetic power or a magnetic path is formed in the magnetic powder after the magnetic power is filled in the cavity, so that a dust core is molded while magnetic orientations of the magnetic power are aligned. Japanese Patent Laid-Open No. 2020-149997 discloses a dust core manufacturing method including filling flat soft magnetic power in a case, impregnating the magnetic power with a hardening resin liquid by imparting vibration or a magnetic field, and causing the hardening resin liquid to harden through vacuum deaeration.

In the case that flattening directions are aligned by imparting vibration to flat soft magnetic powder, the soft magnetic powder need be put in a cavity in small amounts so that the soft magnetic powder is made easy to move in the cavity when vibration is imparted thereto, and it takes a certain amount of time to make this happen. In addition, there may be a case in which a large-sized vibration generator is necessary to vibrate a molding die or a case. Thus, there may be a case in which aligning the magnetic orientations of soft magnetic powder by imparting vibration thereto deteriorates the manufacturability of a dust core.

On the other hand, in the case that a magnetic field is imparted to a molding die, there may be a case in which soft magnetic powder adheres to a punch or a cavity, resulting in a risk of a scoring being generated in a molding die or a product being damaged when a subsequent product is molded. Additionally, in the case that soft magnetic powder is caused to harden using a hardening resin liquid, the position of the soft magnetic powder in which magnetic orientations are aligned need be maintained. As a result, with a dust core having an irregular shape, there may be a case in which the position of soft magnetic powder in which magnetic orientations are aligned is hardly maintained, thereby imposing a limitation on the shape of a dust core to be manufactured.

### SUMMARY OF THE INVENTION

An object of the present invention is to provide a preformed chip manufacturing apparatus, a preformed chip, and a preformed chip manufacturing method for manufacturing a dust core in which a magnetic characteristic and a degree of freedom in shape are improved, and a dust core manufacturing apparatus, a dust core, and a dust core manufacturing method which use the preformed chip.

A preformed chip manufacturing apparatus according to the present invention includes a magnetic fixing suspension device including a pair of magnets between which a magnetic field is formed for enabling soft magnetic powder to be suspended therein, and a pair of punches configured to pressure mold the soft magnetic powder suspended in the magnetic field.

A preformed chip according to the present invention is manufactured by the preformed chip manufacturing apparatus described above.

A dust core manufacturing apparatus according to the present invention includes a molding die configured to install a plurality of the preformed chips.

A dust core according to the present invention is manufactured by the dust core manufacturing apparatus described above.

A preformed chip manufacturing method according to the present invention includes a suspension step of suspending soft magnetic powder in a magnetic field formed between a pair of magnets and a soft magnetic powder pressurization step of pressure molding the soft magnetic powder suspended in the suspension step.

A dust core manufacturing method according to the present invention includes a disposition step of disposing a plurality of preformed chips manufactured by the preformed chip manufacturing method described above in a molding die by aligning magnetic orientations thereof and a pressure molding step of pressure molding the plurality of preformed chips which are so disposed in the disposition step.

According to the present invention, it is possible to provide a preformed chip manufacturing apparatus, a preformed chip, and a preformed chip manufacturing method for manufacturing a dust core in which a magnetic characteristic and a degree of freedom in shape are improved, and a dust core manufacturing apparatus, a dust core, and a dust core manufacturing method which use the preformed chip.

### BRIEF DESCRIPTION OF THE SEVERAL VIEWS OF THE DRAWINGS

FIG. 1 is a perspective view showing a preformed chip according to an embodiment of the present invention.

FIG. 2A is a schematic front view showing a pre-pressure molding state in a preformed chip manufacturing step by a preformed chip manufacturing apparatus according to the embodiment of the present invention.

FIG. 2B is a schematic sectional view taken along a line IIb-IIb in FIG. 2A which shows the pre-pressure molding state in the preformed chip manufacturing step by the preformed chip manufacturing apparatus according to the embodiment of the present invention.

FIG. 3A is a schematic front view showing an in-pressure molding state in the preformed chip manufacturing step by the preformed chip manufacturing apparatus according to the embodiment of the present invention.

FIG. 3B is a schematic sectional view taken along a line IIIb-IIIb in FIG. 3A which shows the in-pressure molding state in the preformed chip manufacturing step by the preformed chip manufacturing apparatus according to the embodiment of the present invention.

FIG. 4 is a schematic plan view of the pre-formed chip manufacturing apparatus including a turret table according to the embodiment of the invention.

FIG. 5 is a perspective view showing a dust core according to the embodiment of the present invention.

FIG. 6 is a schematic sectional view showing a dust core manufacturing apparatus according to the embodiment of the present invention.

FIG. 7 is a perspective view showing another dust core according to the embodiment of the present invention.

FIG. 8A is a schematic plan view showing another dust core manufacturing apparatus according to the embodiment of the present invention.

FIG. 8B is a sectional view taken along a line IIIb-IIIb in FIG. 8A which shows the other dust core manufacturing apparatus according to the embodiment of the present invention.

### DETAILED DESCRIPTION OF THE PREFERRED EMBODIMENT

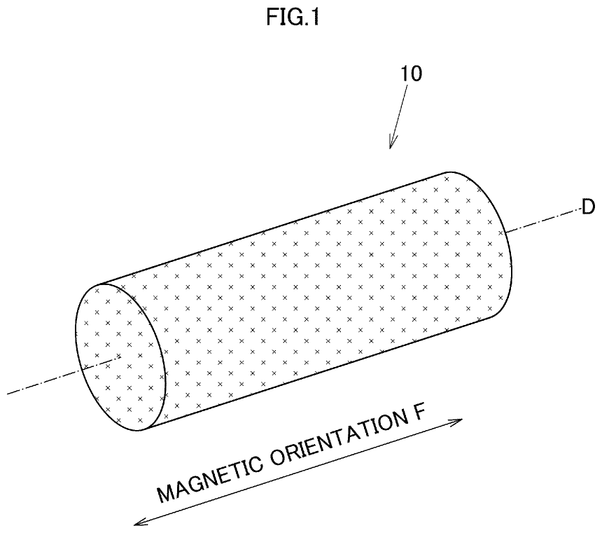

An embodiment of the present invention will be described below by reference to drawings. A preformed chip 10 shown in FIG. 1 is formed by pressure molding soft magnetic powder with a punch 120, which will be described later. Here, soft magnetic powder is powder formed from soft magnetic material. Pure iron, which has a high saturation magnetic flux density and superior plastic deformability exhibited when pressed, and iron-based alloys such as Sendust, silicon steel, permalloy, and the like can be used to form the soft magnetic powder.

The preformed chip 10 is formed into a chip having a long substantially cylindrical shape, and a magnetic orientation F of the preformed chip 10 is set so as to extend along a direction of an axis D thereof. Although a detailed description will be made later, dust cores 51, 51A according to the embodiment of the present invention are each manufactured by pressure molding a plurality of preformed ships 10. The preformed chip 10 can be formed in various sizes and shapes so as to match a dust core to be manufactured. In the present embodiment, the preformed chip 10 can have, for example, a diameter of about 2 mm and a height of about 10 mm.

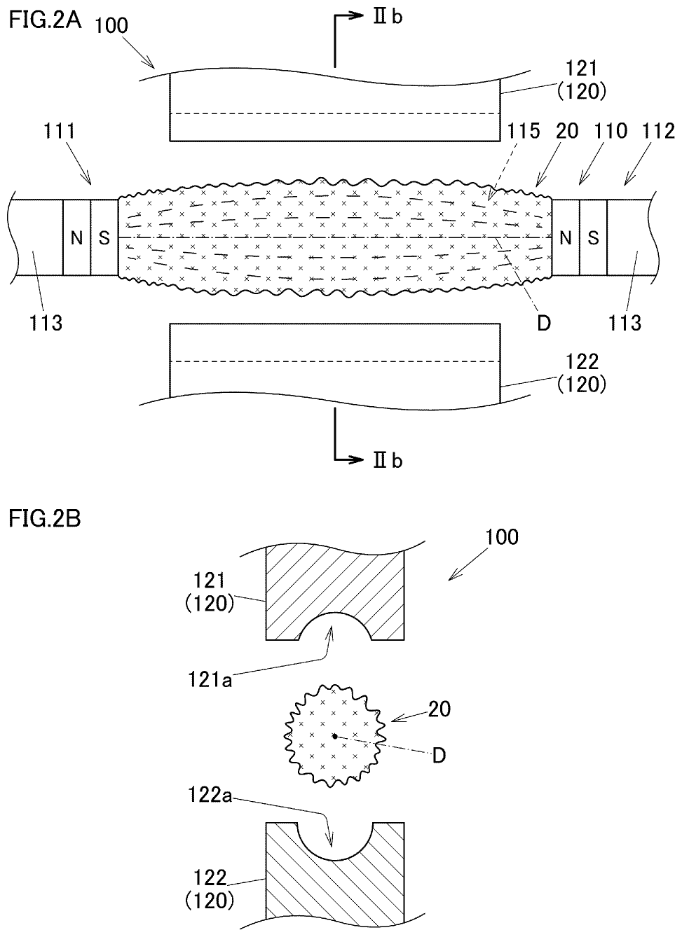

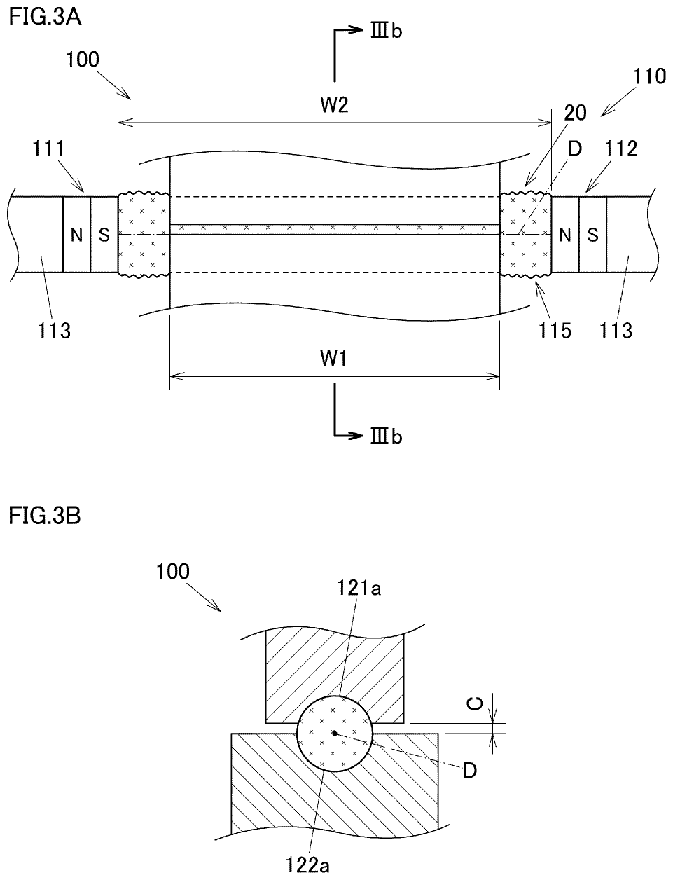

FIGS. 2A, 2B, 3A, and 3B show a manufacturing apparatus 100 of the pre-formed chip 10. The manufacturing apparatus 100 of the preformed chip 10 has a magnetic fixing suspension device 110 and a pair of punches 120 (an upper punch 121, a lower punch 122). The magnetic fixing suspension device 110 has a pair of magnets, that is, a first magnet 111 and a second magnet 112. The first magnet 111 and the second magnet 112 are each formed of a thick circular disc-shaped permanent magnet and are fixed individually to end portions of a support rod 113 of a cylindrical rod-like shape. The first magnet 111 and the second magnet 112 are disposed in such a manner that different magnetic poles face each other in a horizontal direction while being spaced a predetermined space W2 (refer to FIG. 3A) apart from each other. In the present embodiment, an S pole of the first magnet 111 and an N pole of the second magnet 112 face each other. As a result, a magnetic field 115 is formed between the pair of first magnet 111 and second magnet 112.

The magnetic field 115 is formed so that a soft magnetic powder 20 can be suspended therein. In order to allow the soft magnetic powder 20 to be suspended in the magnetic field 115, for example, the magnetic soft powder 20 is caused to fall down freely from above the magnetic field 115, whereby the soft magnetic powder 20 is suspended between the first magnet 111 and the second magnet 112 along a line of magnetic force of the magnetic field 115. At this time, in the case that the punches 120 interfere with the soft magnetic powder 20 which falls down freely, the punches 120 can be put in a state in which the punches 120 stay away from the magnetic field 15 (an offset state). In addition to the permanent magnets, various types of magnets including electromagnets, a combination of a permanent magnet and an electromagnet, or the like can be used for the first magnet 111 and the second magnet 112, as long as the magnetic field 115 where the soft magnetic powder 20 can be suspended is formed therebetween. Additionally, a cover or the like can also be provided on the first magnet 111 and the second magnet 112, as long as the magnetic field 115 is formed between the first magnet 111 and the second magnet 112.

For pressure molding, the punches 120 are disposed in positions where the punches 120 face the magnetic field 115. Specifically speaking, the upper punch 121 is disposed above the magnetic field 115, while the lower punch 122 is disposed below the magnetic field 115. As shown in FIG. 2B, the upper punch 121 and the lower punch 122 have recessed portions 121a, 122a, respectively, which are each formed into a substantially U-shape in a vertical cross section. The punches 120 are configured so as to pressure mold (pressure form) the soft magnetic powder 20 which is suspended in the magnetic field 15, as shown in FIGS. 3A and 3B. An inner space of a substantially cylindrical shape having an axis D is defined by the recessed portions 121a, 122a therebetween.

In addition, as shown in FIG. 3A, a width W1 of the punch 120 is set smaller than the space W2 defined between the first magnet 111 and the second magnet 112. For example, in the present embodiment, the width W1 of the punch 120 is set so that W2-W1=0.20 mm. As a result, a distance from a distal end of the first magnet 111 to the punches 120 and a distance from a distal end of the second magnet 112 to the punches 120 are each set to 0.10 mm.

A pre-formed chip manufacturing method of manufacturing the preformed chip 10 using the manufacturing apparatus 100 described above can be configured so as to include a suspension step, a soft magnetic powder pressurizing step, and a preformed chip removing step of removing the preformed chip 10, as will be described below.

The suspension step is such that the soft magnetic powder 20 is caused to fall down freely from above the magnetic field 115 which is formed between the pair of magnets, that is, the first magnet 111 and the second magnet 112, so that the soft magnetic powder 20 is suspended over the space defined between the first magnet 111 and the second magnet 112. At this time, in the case that the punches 120 interfere with the soft magnetic powder 20 so suspended, the punches 120 can also be caused to stay offset from the magnetic fixing suspension device 110. As a result, the upper punch 121 is prevented from disturbing the free fall of the soft magnetic powder 20, and the soft magnetic powder 20 which is falling down freely is prevented from falling down on the recessed portion 22a of the lower punch 122 to be disposed therein.

The soft magnetic powder pressurizing step is such that in the case that the punches 120 are caused to stay offset from the magnetic field 115 of the magnetic fixing suspension device 110, the punches 120 are disposed in the positions where the punches 120 face the suspended soft magnetic powder 20 (the magnetic field 115), so that the soft magnetic powder 20, which is suspended in the suspension step, is pressure molded by the punches 120. The upper punch 121 and the lower punch 122 are caused to move in a direction in which the recess portion 121a of the upper punch 121 and the recessed portion 122a of the lower punch 122 move towards each other, whereby the preformed chip 10 is pressure molded. When the soft magnetic powder 20 is pressure molded by the punches 120, a clearance C (refer to FIG. 3B) is defined between the punches 120. In the present embodiment, for example, the clearance C can be set to 0.05 mm.

The pre-formed chip removing step of removing the preformed chip 10 is such that when the punches 120 are opened by separating the upper punch 121 and the lower punch 122 from each other, the soft magnetic powder 20 confined between the first magnet 111 and the second magnet and between the punches 120 collapses to fall down, whereby a preformed chip 10 which is a pressure molded soft magnetic powder 20 is left within the recessed portion 122a of the lower punch 122 of the punches 120. The pre-formed chip 10 remaining within the recessed portion 122a is removed from the lower punch 122 with an appropriate means.

The soft magnetic powder 20 suspended in the magnetic field 115 in the suspension step is magnetically oriented in the direction of the magnetic field 115 (that is, the orientation of a magnetic field). That is, the soft magnetic powder 20 which is suspended in the suspension step is such that axes of easy magnetization of individual powder of the soft magnetic powder 20 are aligned in the orientation of the magnetic field 115 by the magnetic field 115. The orientation of the magnetic field 115 is substantially the same as the axis D of the cylindrical shape defined by the recessed portions 121a, 122a. Then, the preformed chip 10 is manufactured by pressure molding the soft magnetic powder 20 which is being suspended by the magnetic field 115. Thus, a magnetic orientation F of the preformed chip 10 is formed along the axis D (refer to FIG. 1).

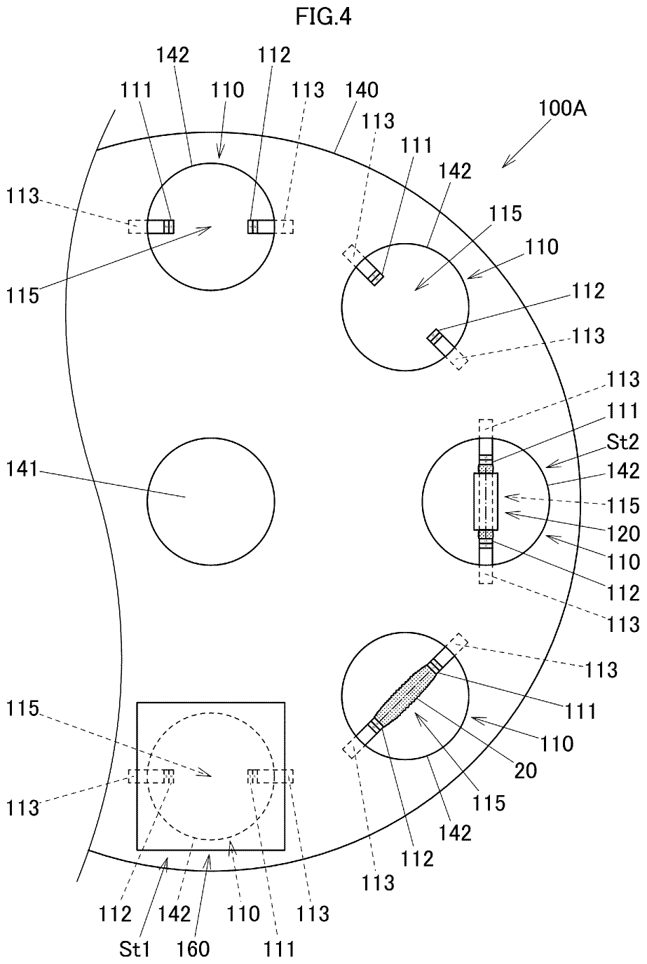

With the preformed chip 10, a manufacturing apparatus for mass manufacturing of preformed chips 10 can be configured by making various modifications to the manufacturing apparatus 100 of the preformed chip 10 as a base configuration. For example, FIG. 4 shows a manufacturing apparatus 100A of the preformed chip 10 which includes a turret table 140. A plurality of magnetic fixing suspension devices 110 are provided on the turret table 140, which is rotated intermittently by a drive shaft 141, of the manufacturing apparatus 100A. The magnetic fixing suspension devices 110 are provided in hole portions 142 which are provided in the turret table 140 in such a manner that different magnetic poles of a first magnet 111 and a second magnet 112 face each other. A soft magnetic powder discharge device 160 is provided above a stage St1 which is located in a six o'clock position on the turret table 140 as seen in FIG. 4, and this soft magnetic powder discharge device 160 is configured to discharge a soft magnetic powder 20 in such a manner that the soft magnetic powder 20 falls down freely to a magnetic field 115 which is formed between the first magnet 111 and the second magnet 112.

In FIG. 4, punches 120 are provided at a stage St2 which is located in a three o'clock position on the turret table 140. The soft magnetic powder 20, which is suspended in the magnetic field 115 at the stage St1, is pressure molded by the punches 120 at the stage St2 so as to be formed into a cylindrical shape as a pre-formed chip 10. The preformed chip 10 which is pressure molded by the punches 120 is removed from the stage St2 by a removing device or the like, which is not shown.

In this way, the suspension step, the soft magnetic powder pressurizing step, and the removing step of the preformed chip 10 can be continuously performed by rotating the turret table 140 intermittently in one direction (a counterclockwise direction in FIG. 4). As a result, with the manufacturing apparatus 100A including the turret table 140 on which the plurality of magnetic fixing suspension devices 110 are provided, a mass manufacturing of preformed chips 10 can be executed.

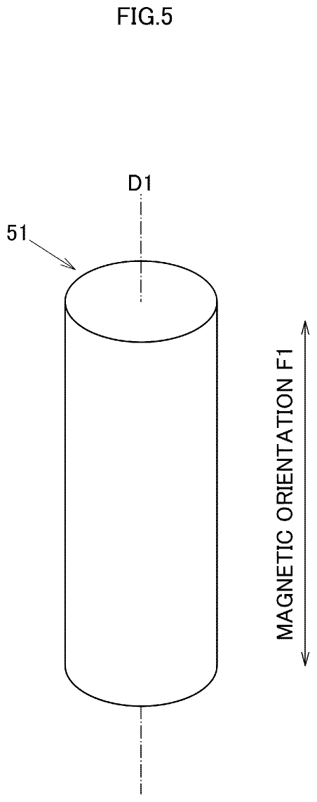

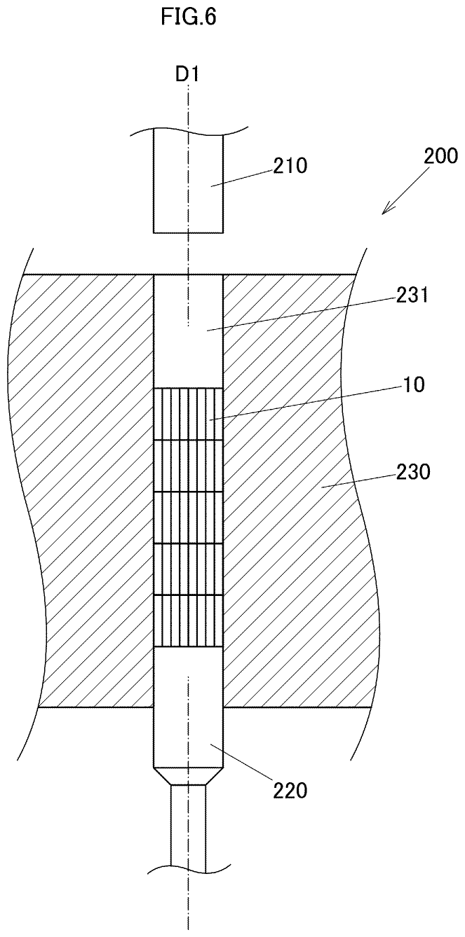

A dust core can be manufactured by disposing a plurality of preformed chips 10, which are manufactured as described above, in an interior of a predetermined molding die and pressure molding the plurality of pre-formed chips 10 so disposed. For example, a long cylindrical dust core 51 shown in FIG. 5 can be manufactured with a manufacturing apparatus 200 of a dust core 51 shown in FIG. 6. The manufacturing apparatus 200 includes a mold, that is, an upper punch 210, a lower punch 220, and a die 230. The lower punch 220 is inserted into a through hole 231 which is provided in the die 230 in such a manner as to extend therethrough in an up-down direction.

A manufacturing method of manufacturing the dust core 51 can be configured so as to include a disposition step, a pressure molding step, and a removing step of removing the dust core 51, as will be described below.

The disposition step is such that a plurality of pre-formed chips 10 are disposed in the die 230 while aligning magnetic orientations F of the plurality of pre-formed chips 10. In the manufacturing apparatus 200, the pre-formed chips 10 are disposed inside the through hole 231 in the die 230 in such a manner that the direction (the direction of an axis D1) in which the through hole 231 penetrates the die 230 substantially coincides with the magnetic orientations F of the pre-formed chips 10.

The pressure molding step is such that the upper punch 210 is inserted into the through hole 231 in the die 230 to pressure mold the plurality of preformed chips 10 disposed in the through hole 231. The preformed chips 10 loaded in the through hole 231 in the die 230 partially collapse on surfaces thereof due to a pressurizing force applied by the upper punch 210 and the lower punch 220, whereby the adjacent pre-formed chips 10 are joined together. As a result, the molding pressure in the soft magnetic powder pressurizing step of the manufacturing method of manufacturing the preformed chip 10 is preferably equal to or smaller than the molding pressure in the pressure molding step of the manufacturing method of manufacturing the dust core 51 and equal to or larger than a pressure (for example, about 5.88×108 Pa (about 6 tomf/cm²)) at which the form of the pre-formed chip 10 can be maintained even after the soft magnetic powder 20 is separated from the punches 120 in the manufacturing method of manufacturing the preformed chip 10.

The removing step of removing the dust core 51 is such that a dust core 51 which is molded and is left in the through hole 231 in the die 230 after the plurality of preformed chips 10 loaded in the through hole 231 are pressure molded is removed by lowering the lower punch 220 downwards or the like.

The dust core 51 is formed by pressure molding the preformed chips 10 which are disposed in such a manner that the magnetic orientations F of the preformed chips 10 are aligned with the direction of the axis D1 of the dust core 51 (that is the direction of the axis D1 of the mold (the through hole 231 in the die 230). As a result, a magnetic orientation F1 of the dust core 51 is aligned with the direction of the axis D1 thereof. Thus, the dust core 51 has a high magnetic permeability in the direction of the axis D1. In this way, the dust core 51 with the improved magnetic characteristic can be manufactured.

The dust core 51 can be used for a core around an outer circumference of which a copper coil is wound. In this case, since an electric current generated by the copper coil flows in the direction of the axis D1 of the core, an eddy-current loss, that is, an iron loss is generated in the direction of the axis D1. With the core of the dust core 51, however, since the magnetic orientation F1 is oriented in the direction of the axis D1, the iron loss can be reduced.

Then, in the case that a diameter of the dust core 51 is of the order of 8 mm, although it is difficult to provide a line of magnetic force generation device on, for example, the upper punch 210 or the lower punch 220, there will be caused no such problem. As the manufacturing method of manufacturing the dust core 51 having the high magnetic permeability in the direction of the axis D1, a configuration can be considered in which the upper punch 210 and the lower punch 220 themselves are magnetized to pressure mold a soft magnetic powder, which is in a powder state. With this configuration, however, metallic powder of soft magnetic powder adheres to the upper punch 210 and the lower punch 220, resulting in a problem in that the operation of the mold is disturbed. However, with the embodiment of the present invention, this type of concern can be eliminated.

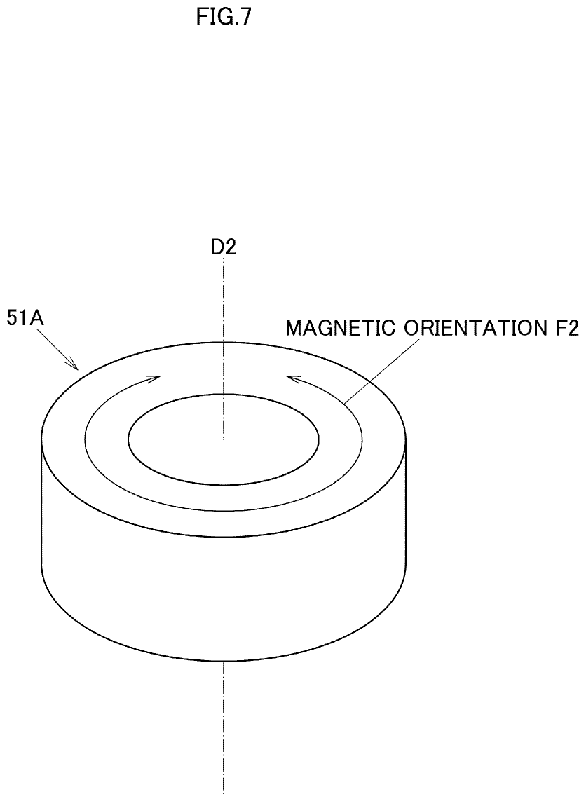

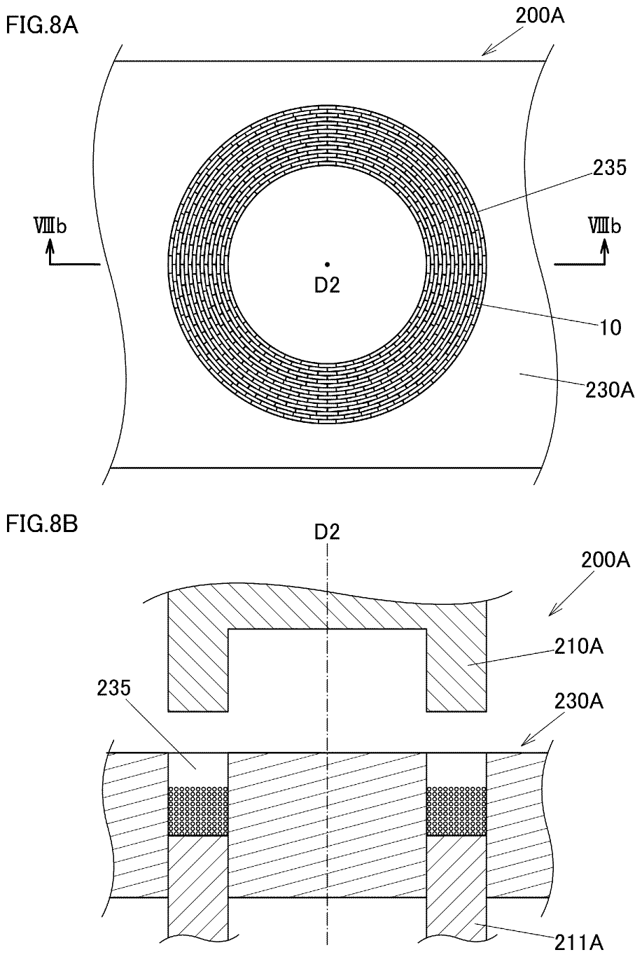

The dust core can take other shapes. An annular dust core 51A shown in FIG. 7 is manufactured using a manufacturing apparatus 200A of a dust core 51A shown in FIG. 8. The manufacturing apparatus 200A includes, as a mold, an upper punch 210A, a lower punch 211A, and a lower die 230A. An annular cavity 235 is formed together with the lower punch 211A in the lower die 230A. The upper punch 210A is formed into an annular shape so as to match the cavity 235. In manufacturing the dust core 51A, preformed chips 10 are disposed in the cavity 235 while magnetic orientations F2 thereof are aligned. Specifically speaking, axes D2 of the preformed chips 10 (that is, longitudinal directions thereof) are disposed around an axis D2 of the cavity 235.

In this way, the plurality of preformed chips 10 loaded in the cavity 235 are pressure molded by the upper punch 210A which constitutes an upper die, and thereafter, the preformed chips 10 so pressure molded are removed from the lower die 230A in the direction of the axis D2 by the lower punch 211A, whereby a dust core 51A can be obtained in which magnetic orientations F2 are aligned in a circumferential direction around the axis D2.

Thus, while the embodiment of the present invention has been described heretofore, the present invention is not limited in any way by the embodiment, and hence, can be carried out while being modified variously. For example, in manufacturing the dust cores 51, 51A, the preformed chips 10 which have been pressure molded may be heated to be calcined. In addition, in manufacturing the preformed chip 10, various types of binders may be mixed into the soft magnetic powder 20 to form a preformed chip 10.

The shape of the preformed chip 10 is not limited to the long cylindrical shape, and hence, various shapes can be adopted so as to match shapes of dust cores to be manufactured. Then, a dust core of an arbitrary shape in which a magnetic characteristic in an arbitrary direction is improved can be manufactured by use of the preformed chip 10 so manufactured.

What is claimed is:

1. A preformed chip manufacturing apparatus comprising:
a magnetic fixing suspension device comprising a pair of magnets between which a magnetic field is formed for enabling a soft magnetic powder to be suspended therein; and
a pair of punches configured to pressure mold the soft magnetic powder suspended in the magnetic field.

2. The preformed chip manufacturing apparatus according to claim 1,
wherein the magnetic field where the soft magnetic powder can be suspended in a long shape is formed in the magnetic fixing suspension device.

3. The preformed chip manufacturing apparatus according to claim 1, further comprising:
a soft magnetic powder discharge device configured to discharge the soft magnetic powder to the magnetic field.

4. The preformed chip manufacturing apparatus according to claim 2, further comprising:
a soft magnetic powder discharge device configured to discharge the soft magnetic powder to the magnetic field.

5. The preformed chip manufacturing apparatus according to claim 1,
wherein a plurality of the magnetic fixing suspension devices are provided on a turret table.

6. The preformed chip manufacturing apparatus according to claim 2,
wherein a plurality of the magnetic fixing suspension devices are provided on a turret table.

7. The preformed chip manufacturing apparatus according to claim 3,
wherein a plurality of the magnetic fixing suspension devices are provided on a turret table.

8. The preformed chip manufacturing apparatus according to claim 4,
wherein a plurality of the magnetic fixing suspension devices are provided on a turret table.

9. A preformed chip manufactured by the preformed chip manufacturing apparatus according to claim 1.

10. A preformed chip manufactured by the preformed chip manufacturing apparatus according to claim 2.

11. A preformed chip manufactured by the preformed chip manufacturing apparatus according to claim 3.

12. A preformed chip manufactured by the preformed chip manufacturing apparatus according to claim 5.

13. A dust core manufacturing apparatus, comprising:
a mold configured to install a plurality of the preformed chips according to claim 9.

14. A dust core manufacturing apparatus, comprising:
a mold configured to install a plurality of the preformed chips according to claim 10.

15. A dust core manufacturing apparatus, comprising:
a mold configured to install a plurality of the preformed chips according to claim 11.

16. A dust core manufacturing apparatus, comprising:
a mold configured to install a plurality of the preformed chips according to claim 12.

17. A dust core manufactured by the dust core manufacturing apparatus according to claim 13.

18. A preformed chip manufacturing method, comprising
a suspension step of enabling a soft magnetic powder to be suspended in a magnetic field formed between a pair of magnets; and
a soft magnetic powder pressurizing step of pressure molding the soft magnetic powder suspended in the suspension step.

19. A dust core manufacturing method, comprising:
a disposition step of disposing a plurality of the preformed chips manufactured by the preformed chip manufacturing method according to claim 18 in a mold while aligning magnetic orientations thereof; and
a pressure molding step of pressure molding the plurality of the preformed chips disposed in the disposition step.

20. The dust core manufacturing method according to claim 19,
wherein a molding pressure in the soft magnetic powder pressurizing step is equal to or smaller than a molding pressure in the pressure molding step.
